(19) United States
(12) Patent Application Publication
(10) Pub. No.: US 2015/0192898 A1
(43) Pub. Date: Jul. 9, 2015

(54) APPARATUS AND METHOD FOR MEASURING AND EVALUATING FIELD OF VIEW (FOV) OF RECONSTRUCTED IMAGE OF HOLOGRAM

(71) Applicant: Electronics and Telecommunications Research Institute, Daejeon (KR)

(72) Inventors: Je Ho NAM, Daejeon (KR); Soo Hyun LEE, Daejeon (KR); Eun Young CHANG, Daejeon (KR)

(21) Appl. No.: 14/588,752

(22) Filed: Jan. 2, 2015

(30) Foreign Application Priority Data
Jan. 3, 2014 (KR) 10-2014-0000549

(51) Int. Cl. G03H 1/08; G03H 1/00

(52) U.S. Cl. CPC G03H 1/0891; G03H 1/0005; G03H 2001/0038; G02B 3/0006

(57) ABSTRACT

An apparatus and method for measuring and evaluating a field of view (FOV) that measures an FOV of a reconstructed image of a hologram, and evaluates a quality of the reconstructed image of the hologram is provided, the apparatus configured to photograph an optically reconstructed hologram image based on an integral imaging scheme to obtain an integral image, measure FOV information using the integral image, calculate FOV information of a source based on three-dimensional (3D) stereoscopic information used in the optical reconstruction of the hologram image, and evaluate an FOV reconstruction quality of the hologram image.

### CROSS-REFERENCE TO RELATED APPLICATION

This application claims the priority benefit of Korean Patent Application No. 10-2014-0000549, filed on Jan. 3, 2014, in the Korean Intellectual Property Office, the disclosure of which is incorporated herein by reference.

### BACKGROUND

1. Field of the Invention

Embodiments of the present invention relate to technology for measuring a field of view (FOV) of a reconstructed image of a hologram and evaluating a quality of the reconstructed image of the hologram.

2. Description of the Related Art

Holographic technology is technology for reconstructing a three-dimensional (3D) image that provides a natural sense of dimension to a viewer by reconstructing a 3D object on a space, and thus addresses an issue of limited representation of a stereoscopic image usually observed in a conventional stereo method. In particular, digital holography technology may generate a computer-generated hologram (CGH) from stereoscopic information of a 3D object and a real object based on an optical diffraction and interference principle using an opto-electronic apparatus, and reconstruct a stereoscopic image in a manner similar to being in an actual space based on an optical display scheme.

Elements determining a quality of a 3D stereoscopic image to be reconstructed in a space through optical reconstruction of a hologram may include a size, brightness, resolution, noise, a field of view (FOV), and depth. One method of evaluating a quality or a resolution of a hologram may be a volume signal-to-noise ratio (VSNR) scheme in which a reconstructed image of a hologram is obtained by applying a depth element to a peak signal-to-noise ratio (PSNR) of image information based on a resolution evaluation method for a conventional two-dimensional (2D) image. The VSNR scheme comprehensively assesses a quality of a hologram by reflecting effects of brightness, diffraction efficiency, and a color reconstruction performance of a display that reconstructs hologram data as well as aspects of hologram content.

An FOV and a sense of depth provided by a hologram are main elements constituting characteristics of the hologram as a 3D image medium. For example, a horizontal/vertical FOV provided by the hologram may be a vital 3D stereoscopic characteristic that generates a motion parallax unobtainable from the conventional stereo method. In general, a maximum FOV reconstructable by a hologram is affected by diffraction efficiency of a photo-sensitive material in which the hologram is recorded or diffraction efficiency of a spatial light modulator (SLM) for optical reconstruction of hologram data. In this instance, a diffraction angle θ is defined based on a grating equation “Λ sin θ=λ,” in which Λ denotes a spatial frequency in a fringe pattern to diffract light, and λ, denotes a wavelength of a reconstructed light input to reconstruct a hologram. In an instance of a digital hologram, a maximum angle of θ is obtained when Λ is two times greater than a pixel pitch “p” of an SLM, for example, “Λ=2p.”

In reconstruction of a hologram, a quality of an FOV and a motion parallax of a reconstructed image may be determined based on 3D information input during generation of the hologram from a perspective of content independent of physical elements such as a diffraction characteristic of a photo-sensitive material, a pixel pitch of an SLM, or a light source wavelength. For example, such a determination is made by a shape of a real object in a 3D space or 3D information obtained as a result of photographing a virtual object or a real object based on a degree of successfully representing a stereoscopic form of a corresponding object in a horizontal or vertical direction.

Also, the quality of the FOV of the hologram is determined based on effects of a CGH algorithm that numerically calculates and generates a hologram using image information and 3D data of an object. In current times, CGH algorithm research generally revolves around attempts to reduce computational complexity and accelerate a computational speed required during a hologram generation process. To decrease a computation amount and enhance a processing speed as desired, reconstruction of 3D stereoscopic elements such as a sense of depth or an FOV may be relatively limited or reduced based on characteristics of an algorithm. However, precise analysis on the limited or reduced reconstruction of the 3D stereoscopic elements and research conducted on an evaluation criterion and method are considerably limited or insufficient.

The quality of the FOV or motion parallax of the reconstructed image on the 3D space through the optical reconstruction of the hologram is provided to a viewer by integrating physical elements, for example, a photo-sensitive material, an SLM of a display, and a light source, stereoscopic characteristics of a 3D object input during content production, and characteristics of a CGH algorithm calculated during hologram generation. For example, a method of comparing images continuously photographed by physically moving a camera in a horizontal or vertical direction by a predetermined angle is adopted to measure an FOV of an optically reconstructed image of a hologram. However, the method may be highly inefficient and lead to inaccurate results. Accordingly, there is a need for an integrated approach and technical implementation that enables consistent processing of precise and efficient measurement of FOV information and evaluation of a quality of the FOV information by obtaining 3D stereoscopic information from an optically reconstructed image of a hologram under such adverse circumstances.

### SUMMARY

An aspect of the present invention provides an apparatus and a method for comprehensively implementing a process of efficiently measuring a field of view (FOV) of a hologram and a process of evaluating a quality of the FOV to solve the aforementioned problem of a related art.

Another aspect of the present invention also provides an apparatus for comprehensively measuring and evaluating a quality of an FOV reconstructed by a hologram by comparatively analyzing features of viewpoint images in horizontal and vertical directions based on directional position information of an elemental image obtained through an integral imaging scheme that efficiently obtains three-dimensional (3D) information of an object.

Still another aspect of the present invention also provides an apparatus and a method for evaluating an FOV reconstruction quality of a hologram by photographing a reconstructed image of a hologram obtained through optical reconstruction of a hologram based on an integral imaging scheme, analyzing 3D information of the hologram from the obtained integral image information, measuring FOV information in horizontal and vertical directions, and comparing the measured FOV information to 3D information of source object data.

According to an aspect of the present invention, there is provided an apparatus for measuring and evaluating an FOV, the apparatus including a 3D photographer to photograph an optically reconstructed hologram image based on an integral imaging scheme, and obtain an integral image, an FOV analyzer to measure FOV information using the integral image; and an FOV evaluator to receive 3D stereoscopic information used in the optical reconstruction of the hologram image, calculate FOV information of a source based on the 3D stereoscopic information to be compared to the measured FOV information, and evaluate an FOV reconstruction quality of the hologram image.

The 3D stereoscopic information may be at least one of a depth map, point cloud data, and 3D mesh model data.

The apparatus for measuring and evaluating the FOV may further include a hologram generator to receive brightness information and the 3D stereoscopic information, and calculate a digital hologram, and a hologram reconstructor to reconstruct information about the digital hologram in a form of the hologram image through an optical reconstruction process.

When the hologram generator receives evaluation information appraising the FOV reconstruction quality of the hologram image, the hologram generator may utilize the evaluation information in calculating a digital hologram to enhance a hologram quality.

The 3D photographer may include a lens array in which multiple microlenses are provided in a form of an array, and an image sensor to photograph, into a single integral image, an elemental image obtained from each of the microlenses of the lens array.

The FOV analyzer may include a viewpoint image generator to reconstruct a 3D object using the integral image, and generate a set of viewpoint images obtained by viewing the reconstructed 3D object from various angles in a horizontal direction and a vertical direction, a horizontal FOV measurer to compare a viewpoint image included in a horizontal viewpoint image set generated by the viewpoint image generator, and calculate a maximum horizontal FOV and a horizontal FOV range, and a vertical FOV measurer to compare a viewpoint image included in a vertical viewpoint image set generated by the viewpoint image generator, and calculate a maximum vertical FOV and a vertical FOV range.

The FOV evaluator may include a maximum FOV comparative evaluator to compare the maximum horizontal FOV included in the FOV information and a maximum horizontal FOV of the source obtained through the 3D stereoscopic image, compare the maximum vertical FOV included in the FOV information and a maximum vertical FOV of the source obtained through the 3D stereoscopic image, and evaluate a maximum FOV of the hologram image, and an FOV range comparative evaluator to compare the horizontal FOV range included in the FOV information and a horizontal FOV range of the source obtained through the 3D stereoscopic image, compare the vertical FOV range included in the FOV information and a vertical FOV range of the source obtained through the 3D stereoscopic image, and evaluate an FOV range of the hologram image.

According to an aspect of the present invention, there is provided a method of measuring and evaluating an FOV, the method including photographing an optically reconstructed hologram image based on an integral imaging scheme, and obtaining an integral image, measuring FOV information using the integral image, and calculating FOV information of a source based on 3D stereoscopic information used in the optical reconstruction of the hologram image to be compared to the measured FOV information, and evaluating an FOV reconstruction quality of the hologram image.

The 3D stereoscopic information may be at least one of a depth map, point cloud data, and 3D mesh model data.

The method of measuring and evaluating the FOV may further include, prior to the obtaining of the integral image, receiving brightness information and the 3D stereoscopic information, and calculating a digital hologram, and reconstructing information about the digital hologram in a form of the hologram image through an optical reconstruction process.

The calculating of the digital hologram may include utilizing, in calculating a digital hologram to enhance a hologram quality, evaluation information appraising the FOV reconstruction quality of the hologram image obtained in the evaluating of the FOV reconstruction quality.

The measuring of the FOV information may include reconstructing a 3D object using the integral image, generating a horizontal viewpoint image set of viewpoint images obtained by viewing the reconstructed 3D object from various angles in a horizontal direction, generating a vertical viewpoint image set of viewpoint images obtained by viewing the reconstructed 3D object from various angles in a vertical direction, comparing a viewpoint image included in the horizontal viewpoint image set, and calculating a maximum horizontal FOV and a horizontal FOV range, and comparing a viewpoint image included in the vertical viewpoint image set, and calculating a maximum vertical FOV and a vertical FOV range.

The evaluating of the FOV reconstruction quality may include comparing the maximum horizontal FOV included in the FOV information and a maximum horizontal FOV of the source obtained through the 3D stereoscopic information, comparing the maximum vertical FOV included in the FOV information and a maximum vertical FOV of the source obtained through the 3D stereoscopic information, and evaluating a maximum FOV of the hologram image, and comparing the horizontal FOV range included in the FOV information and a horizontal FOV range of the source obtained through the 3D stereoscopic information, comparing the vertical FOV range included in the FOV information and a vertical FOV range of the source obtained through the 3D stereoscopic information, and evaluating an FOV range of the hologram image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an apparatus for measuring and evaluating a field of view (FOV) that measures and evaluates an FOV of a reconstructed image of a hologram according to an embodiment of the present invention;

FIG. 2 is a diagram illustrating information to be input/output in a hologram generator of an apparatus for measuring and evaluating an FOV according to an embodiment of the present invention;

FIG. 3 is a diagram illustrating a configuration of a three-dimensional (3D) photographer of an apparatus for measuring and evaluating an FOV according to an embodiment of the present invention;

FIG. 4 is a diagram illustrating a configuration of an FOV analyzer of an apparatus for measuring and evaluating an FOV according to an embodiment of the present invention;

FIG. 5 is a diagram illustrating a configuration of an FOV evaluator of an apparatus for measuring and evaluating an FOV according to an embodiment of the present invention;

FIG. 6 is a flowchart illustrating a process of evaluating an FOV in an apparatus for measuring and evaluating an FOV according to an embodiment of the present invention;

FIG. 7 is a diagram illustrating an example of an integral image according to an embodiment of the present invention; and

FIG. 8 is a diagram illustrating an example of a set of viewpoint images calculated from an integral image according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

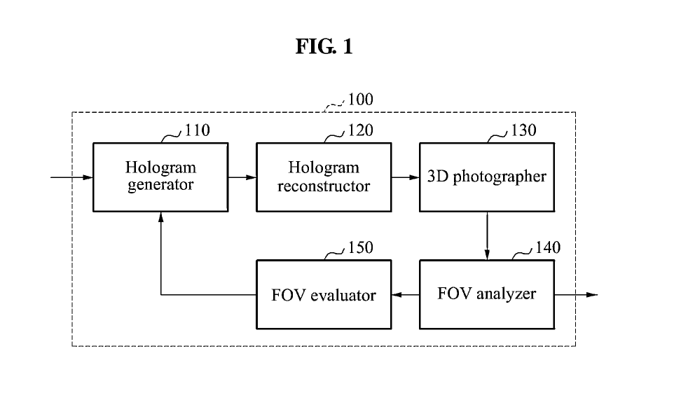

Hereinafter, description pertaining to an apparatus and method for measuring and evaluating a field of view (FOV) of a reconstructed image of a hologram according to an embodiment of the present invention will be provided with reference to FIGS. 1 through 8.

FIG. 1 is a diagram illustrating a configuration of an apparatus 100 for measuring and evaluating an FOV that measures and evaluates an FOV of a reconstructed image of a hologram according to an embodiment of the present invention.

Referring to FIG. 1, the apparatus 100 for measuring and evaluating the FOV includes a hologram generator 110, a hologram reconstructor 120, a three-dimensional (3D) photographer 130, an FOV analyzer 140, and an FOV evaluator 150.

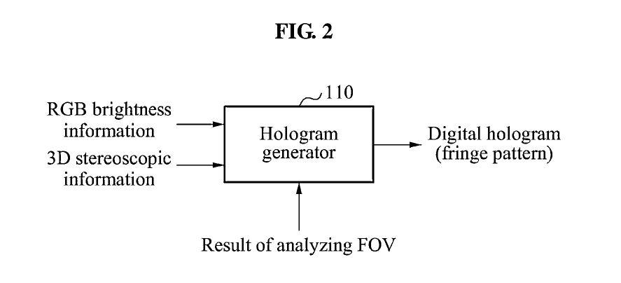

The hologram generator 110 receives brightness information and 3D stereoscopic information, and calculates a digital hologram. Descriptions pertaining to the hologram generator 110 will be provided with reference to FIG. 2.

FIG. 2 is a diagram illustrating information to be input/output in a hologram generator 110 of an apparatus for measuring and evaluating an FOV according to an embodiment of the present invention.

Referring to FIG. 2, the hologram generator 110 receives red green blue (RGB) brightness information and 3D stereoscopic information of a 3D object, and calculates a digital hologram, for example, fringe pattern data, based on a computer-generated hologram (CGH) scheme. In this example, the 3D stereoscopic information may include a depth map, point cloud data, or 3D mesh model data.

When the hologram generator 110 receives evaluation information appraising an FOV reconstruction quality of a hologram image from the FOV evaluator, the hologram generator 110 utilizes the evaluation information in calculating a digital hologram to enhance a hologram quality.

For example, when the evaluation information is less than a reference value, the hologram generator 110 changes an algorithm for calculating the digital hologram to an algorithm for providing a superior quality to enhance the hologram quality.

The hologram reconstructor 120 reconstructs digital hologram information in a form of a hologram image through an optical reconstruction process. Here, an optical configuration of the hologram reconstructor 120 may include a spatial light modulator (SLM), a light source such as laser or a light emitting diode (LED), a lens or a mirror required for optical reconstruction of a hologram to implement optical reconstruction of a digital hologram.

As shown in FIG. 1, the hologram generator 110 and the hologram reconstructor 120 are disposed inside the apparatus 100 for measuring and evaluating the FOV. However, hologram generator 110 and the hologram reconstructor 120 may be separately disposed externally to the apparatus 100 for measuring and evaluating the FOV.

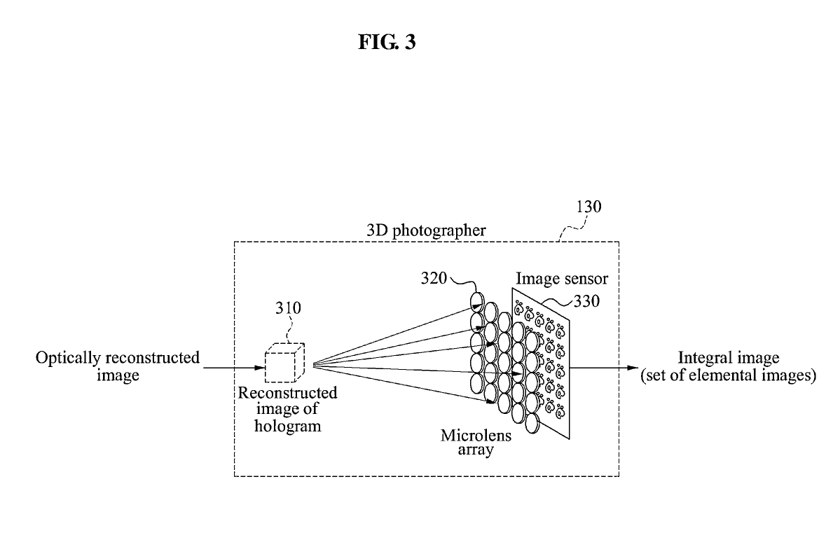

The 3D photographer 130 photographs an optically reconstructed hologram image based on an integral imaging scheme, and obtains an integral image. Descriptions pertaining to a configuration of the 3D photographer 130 will be provided with reference to FIG. 3.

FIG. 3 is a diagram illustrating a configuration of a 3D photographer 130 of an apparatus for measuring and evaluating an FOV according to an embodiment of the present invention.

Referring to FIG. 3, the 3D photographer 130 includes a lens array 320 and an image sensor 330.

The lens array 320 is a set of multiple microlenses provided in a form of an array.

The image sensor 330 photographs, into a single integral image, elemental images obtained from each of the microlenses of the lens array 320.

As used herein, the elemental image refers to an image obtained through each of the microlenses viewing a reconstructed image 310 of a hologram from differing angles. The integral image refers to an image in which all of the elemental images are recorded.

Pixels disposed at an identical position for each of the elemental images indicate rays in an identical progressing direction because each elemental image in an integral image divides rays that pass through a center point of a corresponding microlens based on a progressive direction. Accordingly, ray distribution information for a plurality of directions and positions of a reconstructed image of a hologram may be obtained by photographing the reconstructed image of the hologram based on the integral imaging scheme.

The FOV analyzer 140 measures FOV information using the integral image photographed by the 3D photographer 130.

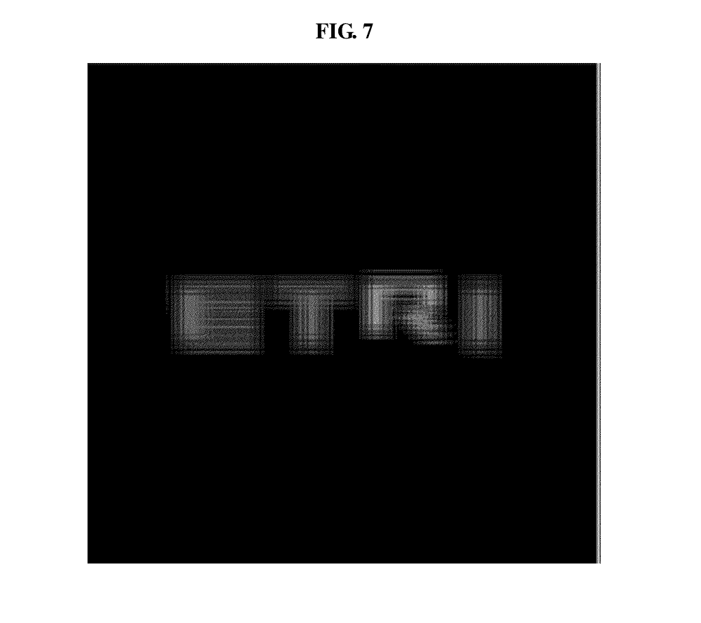

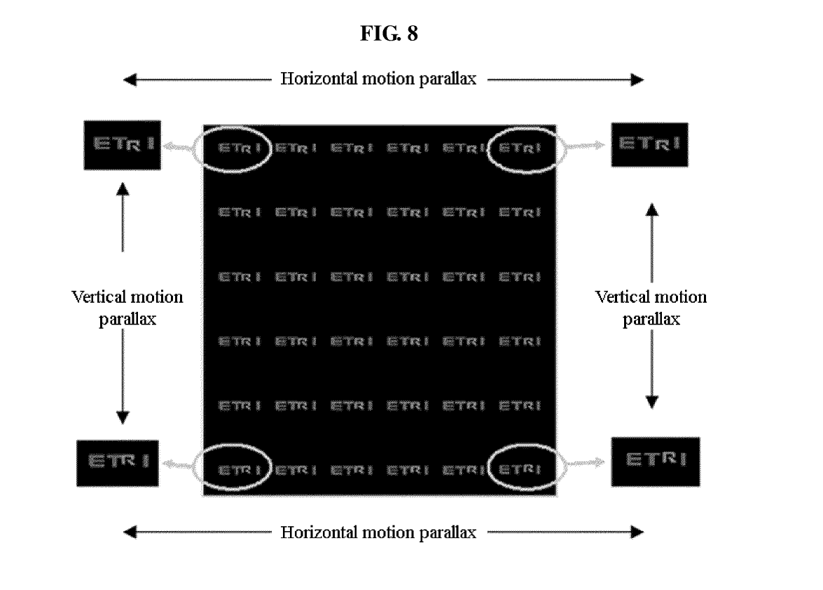

The FOV analyzer 140 generates a set of viewpoint images obtained by viewing a 3D object from various angles in horizontal and vertical directions through re-arranging pixels at an identical position as shown in FIG. 8 from a set of elemental images provided as an example of an integral image as shown in FIG. 7. The FOV analyzer 140 calculates a maximum FOV and an FOV range in horizontal and vertical directions from the set of viewpoint images. A result of the calculation is output to the FOV analyzer 150 as horizontal and vertical FOV information.

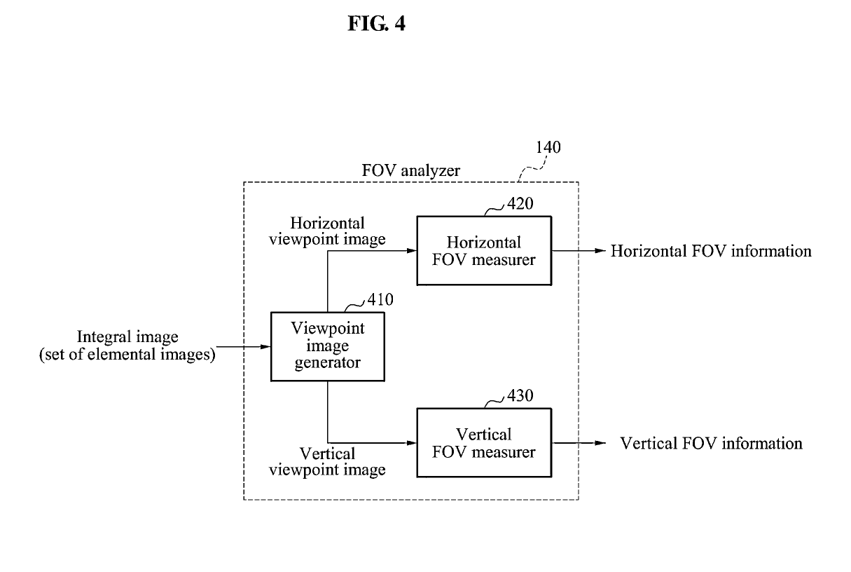

Descriptions pertaining to the FOV analyzer 140 will be provided with reference to FIG. 4.

FIG. 4 is a diagram illustrating a configuration of an FOV analyzer 140 of an apparatus for measuring and evaluating an FOV according to an embodiment of the present invention.

Referring to FIG. 4, the FOV analyzer 140 includes a viewpoint image generator 410, a horizontal FOV measurer 420, and a vertical FOV measurer 430.

The viewpoint image generator 410 reconfigures a 3D object using an integral image, and generates a set of viewpoint images obtained by viewing the reconstructed 3D object from various angles in horizontal and vertical directions.

The horizontal FOV measurer 420 compares a viewpoint image included in a set of horizontal viewpoint images generated by the viewpoint image generator 410, and calculates a maximum horizontal FOV and a horizontal FOV range.

The vertical FOV measurer 430 compares a viewpoint image included in a set of vertical viewpoint images generated by the viewpoint image generator 410, and calculates a maximum vertical FOV and a vertical FOV range.

The FOV evaluator 150 receives 3D stereoscopic information used in optical reconstruction of a hologram image, calculates FOV information of a source based on the 3D stereoscopic information, compares the FOV information measured by the FOV analyzer 140 to the FOV information of the source, and evaluates an FOV reconstruction quality of the hologram image.

The FOV evaluator 150 extracts horizontal/vertical FOV information from 3D stereoscopic information of the source, matches corresponding points amongst the viewpoint images to be compared to the measured horizontal/vertical FOV, and determines a relative displacement amongst the viewpoint images. The FOV information measured by the FOV measurer 140 and the FOV information of the source are evaluated by performing comparative analysis on maximum horizontal and vertical FOVs, a viewpoint image at a maximum FOV, and an FOV range. A method of comparatively analyzing the measured FOV information and the source FOV information may be implemented using various algorithms, and the present invention is not limited to a specific method.

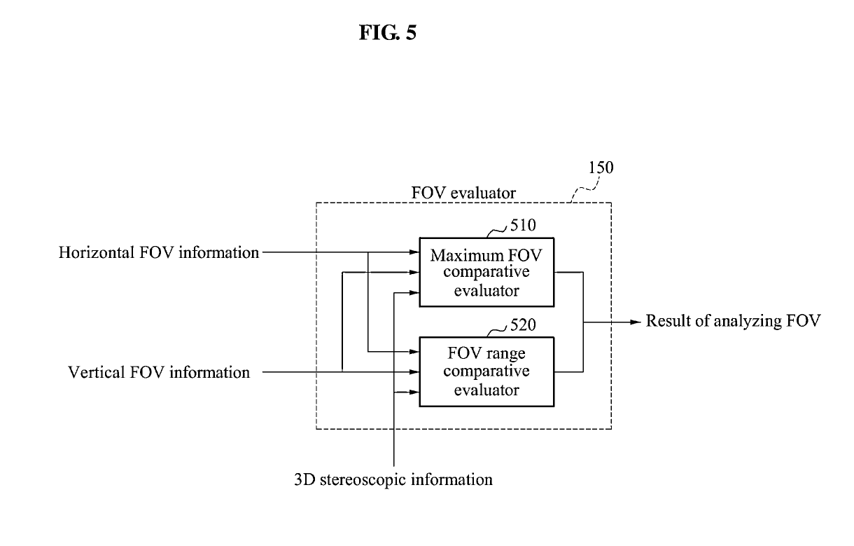

Descriptions pertaining to the FOV evaluator 150 will be provided with reference to FIG. 5.

FIG. 5 is a diagram illustrating a configuration of an FOV evaluator 150 of an apparatus for measuring and evaluating an FOV according to an embodiment of the present invention.

Referring to FIG. 5, the FOV evaluator 150 includes a maximum FOV comparative evaluator 510 and an FOV range comparative evaluator 520.

The maximum FOV comparative evaluator 510 compares a maximum horizontal FOV included in FOV information received from the FOV analyzer 140 and a maximum horizontal FOV of a source obtained through 3D stereoscopic information, compares a maximum vertical FOV included in the FOV information and a maximum vertical FOV of the source obtained through the 3D stereoscopic information, and evaluates a maximum FOV of a hologram image.

The FOV range comparative evaluator 520 compares a horizontal FOV range included in the FOV information received from the FOV analyzer 140 and a horizontal FOV range of the source obtained through the 3D stereoscopic information, compares a vertical FOV range included in the FOV information and a vertical FOV range of the source obtained through the 3D stereoscopic information, and evaluates an FOV range of the hologram image.

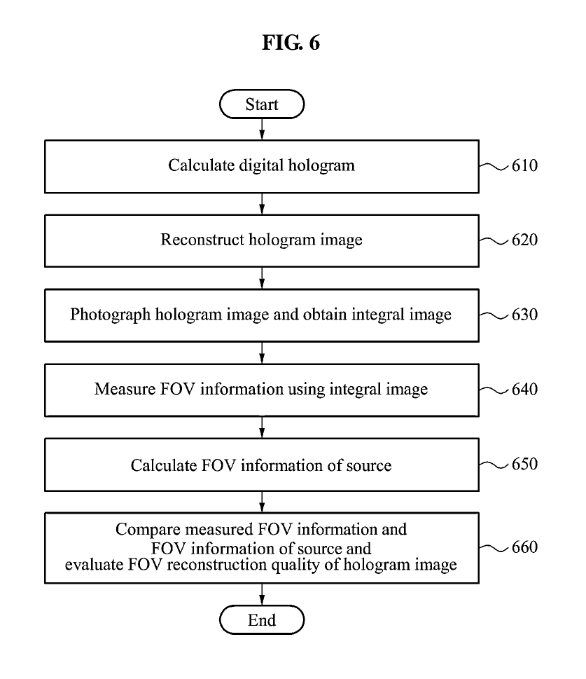

Hereinafter, descriptions pertaining to a method of measuring and evaluating an FOV of a reconstructed image of a hologram according to an embodiment of the present invention will be provided with reference to FIG. 6.

FIG. 6 is a flowchart illustrating a process of evaluating an FOV in an apparatus 100 for measuring and evaluating an FOV according to an embodiment of the present invention.

Referring to FIG. 6, in operation 610, the apparatus 100 for measuring and evaluating the FOV receives brightness information and 3D stereoscopic information, and calculates a digital hologram.

Here, the 3D stereoscopic information may include a depth map, point cloud data, or 3D mesh model data.

In operation 620, the apparatus 100 for measuring and evaluating the FOV reconstructs digital hologram information in a form of a hologram image through an optical reconstruction process.

In operation 630, the apparatus 100 for measuring and evaluating the FOV photographs an optically reconstructed hologram image based on an integral imaging scheme, and obtains an integral image.

In operation 640, the apparatus 100 for measuring and evaluating the FOV measures FOV information using the integral image.

In operation 650, the apparatus 100 for measuring and evaluating the FOV calculates FOV information of a source based on the 3D stereoscopic information used in the optical reconstruction of the hologram image.

In operation 660, the apparatus 100 for measuring and evaluating the FOV compares the measured FOV information and the FOV information of the source, and evaluates an FOV reconstruction quality of the hologram image.

According to an embodiment of the present exemplary embodiment, there is provided an apparatus and system for measuring and evaluating an FOV of a reconstructed image of a hologram that measures a maximum FOV and an FOV range in horizontal and vertical directions of an optically reconstructed hologram image from a hologram, analyzing by comparing a result of the measurement to FOV information of a 3D source object, and thus objectively evaluating an FOV reconstruction quality of the hologram. Also, according to an embodiment of the present exemplary embodiment, it is possible to efficiently utilize the FOV quality obtained as described above to evaluate a performance of a hologram signal processing algorithm such as hologram generation and compression/encoding and a performance of a holographic display.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for measuring and evaluating a field of view (FOV), the apparatus comprising:
a three-dimensional (3D) photographer to photograph an optically reconstructed hologram image based on an integral imaging scheme, and obtain an integral image;
an FOV analyzer to measure FOV information using the integral image; and
an FOV evaluator to receive 3D stereoscopic information used in the optical reconstruction of the hologram image, calculate FOV information of a source based on the 3D stereoscopic information to be compared to the measured FOV information, and evaluate an FOV reconstruction quality of the hologram image.

2. The apparatus of claim 1, wherein the 3D stereoscopic information is at least one of a depth map, point cloud data, and 3D mesh model data.

3. The apparatus of claim 1, further comprising:
a hologram generator to receive brightness information and the 3D stereoscopic information, and calculate a digital hologram; and
a hologram reconstructor to reconstruct information about the digital hologram in a form of the hologram image through an optical reconstruction process.

4. The apparatus of claim 3, wherein when the hologram generator receives evaluation information appraising the FOV reconstruction quality of the hologram image, the hologram generator utilizes the evaluation information in calculating a digital hologram to enhance a hologram quality.

5. The apparatus of claim 1, wherein the 3D photographer comprises:
a lens array in which multiple microlenses are provided in a form of an array; and
an image sensor to photograph, into a single integral image, an elemental image obtained from each of the microlenses of the lens array.

6. The apparatus of claim 1, wherein the FOV analyzer comprises:
a viewpoint image generator to reconstruct a 3D object using the integral image, and generate a set of viewpoint images obtained by viewing the reconstructed 3D object from various angles in a horizontal direction and a vertical direction;
a horizontal FOV measurer to compare a viewpoint image included in a horizontal viewpoint image set generated by the viewpoint image generator, and calculate a maximum horizontal FOV and a horizontal FOV range; and
a vertical FOV measurer to compare a viewpoint image included in a vertical viewpoint image set generated by the viewpoint image generator, and calculate a maximum vertical FOV and a vertical FOV range.

7. The apparatus of claim 1, wherein the FOV evaluator comprises:
a maximum FOV comparative evaluator to compare the maximum horizontal FOV included in the FOV information and a maximum horizontal FOV of the source obtained through the 3D stereoscopic image, compare the maximum vertical FOV included in the FOV information and a maximum vertical FOV of the source obtained through the 3D stereoscopic image, and evaluate a maximum FOV of the hologram image; and
an FOV range comparative evaluator to compare the horizontal FOV range included in the FOV information and a horizontal FOV range of the source obtained through the 3D stereoscopic image, compare the vertical FOV range included in the FOV information and a vertical FOV range of the source obtained through the 3D stereoscopic image, and evaluate an FOV range of the hologram image.

8. A method of measuring and evaluating a field of view (FOV), the method comprising:
photographing an optically reconstructed hologram image based on an integral imaging scheme, and obtaining an integral image;
measuring FOV information using the integral image; and
calculating FOV information of a source based on three-dimensional (3D) stereoscopic information used in the optical reconstruction of the hologram image to be compared to the measured FOV information, and evaluating an FOV reconstruction quality of the hologram image.

9. The method of claim 8, wherein the 3D stereoscopic information is at least one of a depth map, point cloud data, and 3D mesh model data.

10. The method of claim 8, further comprising, prior to the obtaining of the integral image:
receiving brightness information and the 3D stereoscopic information, and calculating a digital hologram; and
reconstructing information about the digital hologram in a form of the hologram image through an optical reconstruction process.

11. The method of claim 10, wherein the calculating of the digital hologram comprises:
utilizing, in calculating a digital hologram to enhance a hologram quality, evaluation information appraising the FOV reconstruction quality of the hologram image obtained in the evaluating of the FOV reconstruction quality.

12. The method of claim 8, wherein the measuring of the FOV information comprises:
reconstructing a 3D object using the integral image;
generating a horizontal viewpoint image set of viewpoint images obtained by viewing the reconstructed 3D object from various angles in a horizontal direction;
generating a vertical viewpoint image set of viewpoint images obtained by viewing the reconstructed 3D object from various angles in a vertical direction;
comparing a viewpoint image included in the horizontal viewpoint image set, and calculating a maximum horizontal FOV and a horizontal FOV range; and
comparing a viewpoint image included in the vertical viewpoint image set, and calculating a maximum vertical FOV and a vertical FOV range.

13. The method of claim 8, wherein the evaluating of the FOV reconstruction quality comprises:
comparing the maximum horizontal FOV included in the FOV information and a maximum horizontal FOV of the source obtained through the 3D stereoscopic information, comparing the maximum vertical FOV included in the FOV information and a maximum vertical FOV of the source obtained through the 3D stereoscopic information, and evaluating a maximum FOV of the hologram image; and
comparing the horizontal FOV range included in the FOV information and a horizontal FOV range of the source obtained through the 3D stereoscopic information, comparing the vertical FOV range included in the FOV information and a vertical FOV range of the source obtained through the 3D stereoscopic information, and evaluating an FOV range of the hologram image.
